(19) United States
(12) Patent Application Publication
(10) Pub. No.: US 2011/0100750 A1
(43) Pub. Date: May 5, 2011

(54) ADJUSTABLE HARNESS

(76) Inventor: Thomas McCracken, New York, NY (US)

(21) Appl. No.: 12/939,839

(22) Filed: Nov. 4, 2010

Related U.S. Application Data
(60) Provisional application No. 61/258,340, filed on Nov. 5, 2009.

(51) Int. Cl. A62B 35/00

(52) U.S. Cl. 182/3

(57) ABSTRACT

A harness for securing a child in a parade carry position is provided that includes a first strap having a first end and a second end opposite the first end, the first strap comprising a buckle at the second end; and a second strap having a first end and a second end opposite the first end, the second strap comprising a buckle at the second end, wherein the buckle at the second end of the second strap is capable of being removably coupled to the buckle at the second end of the first strap, and wherein each of the first ends of the first and second strap include a cinchable loop.

### CLAIM OF PRIORITY

This application claims the benefit of U.S. Provisional Application No. 61/258,340, filed Nov. 5, 2009, which is incorporated herein by reference.

### BACKGROUND OF THE INVENTION

The present application relates to harnesses and more particularly adjustable harnesses for children.

Pre-verbal children & parents are different heights. This fact inhibits listening and makes emerging language more difficult to perceive. Carrying a child at optimum ear/mouth level (referred to as “the parade carrying position”) is tiring and dangerous. A child being carried in this position is inherently unstable requiring constant hand support to their feet to prevent the child falling backward. This unstable position fosters posture fatigue for the carrier and a need to hang-on-for-dear-life for the child. It is exhilarating but tiring for both parties. The experience therefore mostly remains a novelty, leaving the carrying position of limited utility as a teaching tool. Accordingly, there is a need for a harness that may be used to firmly secure a child riding on an adult's shoulders that reduces the fatigue on the carrier.

### SUMMARY OF THE INVENTION

A harness is therefore provided that firmly harnesses the feet of the child to the torso of the adult, creating a stable, secure carrying position, which facilitates comfort and improved communication between the child and the person carrying the child. The experience of carrying the child in the parade position, i.e., on the carrier's shoulders, therefore, is transformed into a potential language laboratory.

In at least one embodiment, a harness for securing a child in a parade carry position is provided that includes a first strap having a first end and a second end opposite the first end, the first strap comprising a buckle at the second end; and a second strap having a first end and a second end opposite the first end, the second strap comprising a buckle at the second end, wherein the buckle at the second end of the second strap is capable of being removably coupled to the buckle at the second end of the first strap, and wherein each of the first ends of the first and second strap include a cinchable loop.

In at least one embodiment, at least one of the buckles at the second end of the first and second straps are cinchable.

In at least one embodiment, the cinchable loop of at least one of the straps has a fixed length, and wherein the cinchable loop comprises a tubular member disposed over the fixed loop that is capable of sliding at least a portion of the length of the strap, the cinchable loop cinched by sliding the tubular member toward the first end of the strap and loosed by sliding the tubular member toward the second end of the strap.

In at least one embodiment, wherein the tubular member includes a plurality of tubular cavities extending lengthwise through the tubular member, and wherein the cinchable loop passes through both tubular cavities consecutively, the loop therewith forms a stop that prevents the tubular member from sliding off of the first end of the strap and sliding beyond the length of the loop toward the second end of the strap.

In at least one embodiment, the tubular member has a figure-8 cross section.

In at least one embodiment, the fixed length of the loop is from about 10″ to about 24″.

In at least one embodiment, at least one of the straps has an overall length from about 4′ to about 6′.

In at least one embodiment, the tubular member is made from a fabric material sewn into a tubular shape.

In at least one embodiment, the tubular member includes a sliding stop that prevents the tubular member from opening when in a cinched position.

In at least one embodiment, a method for securing a child in a parade carry position is provided that includes the steps of: securing to a child's foot a first strap having a first end and a second end opposite the first end, the first strap comprising a buckle at the second end; securing to a child's other foot a second strap having a first end and a second end opposite the first end, the second strap comprising a buckle at the second end, wherein the buckle at the second end of the second strap is capable of being removably coupled to the buckle at the second end of the first strap, and wherein each of the first ends of the first and second strap include a cinchable loop to which the child's feet are secured; locating the child on an adult's shoulders; wrapping the second end of each of the first and the second straps around the adult's back; and buckling the second ends of the straps to each other at the front of the adult.

In at least one embodiment, at least one of the buckles at the second end of the first and second straps are cinchable, the method includes cinching the straps at the cinchable second end.

In at least one embodiment, the cinchable loop of at least one of the straps has a fixed length, and wherein the cinchable loop comprises a tubular member disposed over the fixed loop that is capable of sliding at least a portion of the length of the strap, the cinchable loop cinched by sliding the tubular member toward the first end of the strap and loosed by sliding the tubular member toward the second end of the strap, and wherein securing at least one of the child's fee includes sliding the tubular member toward the first end of the strap.

Additional aspects of the present invention will be apparent in view of the description which follows.

### BRIEF DESCRIPTION OF THE FIGURES

FIG. 1 shows an adjustable harness according to at least one embodiment of the harnesses disclosed herein;

FIG. 2a shows an adjustable harness according to at least one embodiment of the harnesses disclosed herein placed around a child's ankle;

FIG. 2b shows an adjustable harness according to at least one embodiment of the harnesses disclosed herein placed over the child's foot;

FIGS. 3a-3b show an adjustable harness according to at least one embodiment of the harnesses disclosed herein secured to the child's foot;

FIGS. 4a-4b show an adjustable harness according to at least one embodiment of the harnesses disclosed herein placed around the adult's back and buckled at the adult's waist; and

FIGS. 5a-5c show a buckle for an adjustable harness according to at least one embodiment of the harnesses disclosed herein.

### DETAILED DESCRIPTION OF THE INVENTION

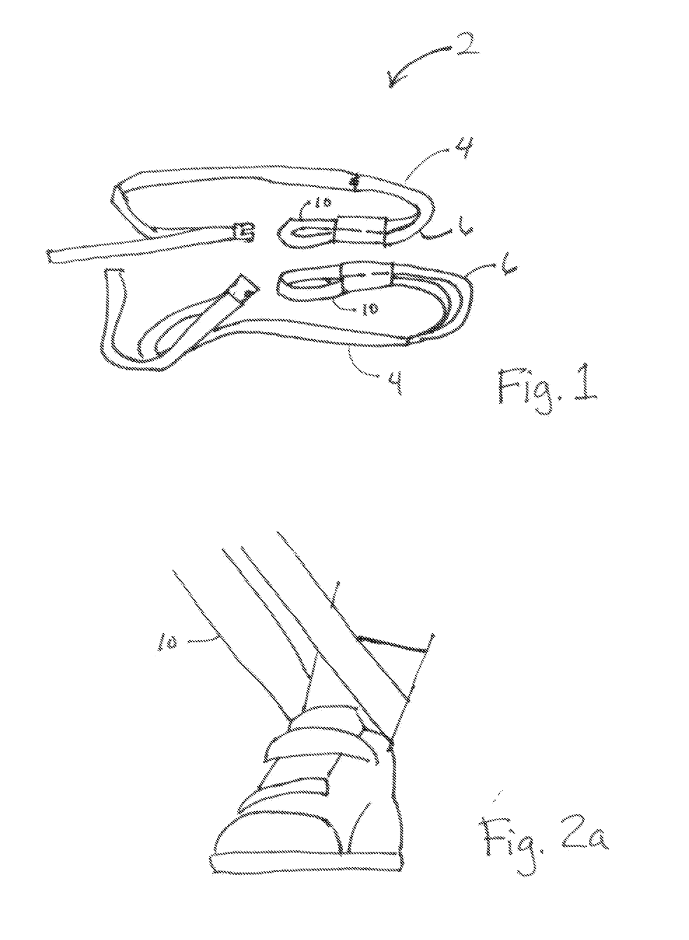

Referring to FIG. 1, a harness 2 is provided that includes a set of two straps 4. Each of the straps 4 has an overall length of about 4 feet to about 6 feet, or preferably about 5 feet. Each of the straps 4 has a first end and a second end opposite the first end. At the first end, the straps 4 include cinchable loop 10. At the second end one of the straps includes a cinchable male buckle and the other strap includes a cinchable female buckle, which buckles are capable of being removably coupled to each other. The straps 4 may be between ⅜″ to about 2″ wide or preferably about 1″ wide. The straps may be made from any synthetic or natural material, including nylon, cotton, etc.

The cinchability of the loop 10 may be achieved in a variety of ways. In one embodiment, the loop 10 has a fixed length, e.g. of about 10″ to about 24″, or preferably about 16″, sewn into the first end of a strap 4. In this instance, a tubular member 6 may be disposed over the loop 10 so that the tubular member 6 is capable of sliding along at least a portion of the length of the strap 4. The loop 10 may therefore be cinched by sliding the tubular member 6 toward the first end of the strap 4 and loosened by sliding the tubular member 6 in the opposite direction toward the second end. The tubular member 6 may also be limited in its ability to slide lengthwise, for example, to prevent the tubular member 6 from falling off of the first end of the strap 4 or from moving too far toward the second end of the strap 4. In one embodiment, this is achieved with a tubular member 6 that has two tubular cavities that extent lengthwise through the tubular member 6 and the loop 10 passes consecutively through both of the two cavities. In this instance, the tubular member 6 has a figure-8 cross section, which allows the tubular member 6 to slide the length of the loop 10 while also being contained within the loop 10.

The tubular member may be made from a thick belt-like fabric cut to a length of about 5¼″ and to width of about 3″. In this instance, the ends of the fabric tubular member 6 are sewn together forming an elongated tube, then sewn together again to form the figure-8 tube. The member 6 may also include sewn onto one end of the tube Velcro, e.g., ½″ about 6″ long, that acts as a slide stop to prevent the loop 10 from opening once cinched. The set of straps 4 may be provided with a carrying pouch, such as a draw string bag, capable of containing the straps rolled up in a compact for when not in use.

It is understood that the functionality of the specific components of the harness discussed herein, such as straps, fabrics, etc. may be achieved with other similar articles. For example, rope may be substituted for the tubular nylon strapping and a metal or some other type of rigid ring could be used to snug the loop. Additionally, there is a range of size and style of strapping material which could be substituted effectively. Accordingly, the harness of the present application is not limited to any one specific embodiment disclosed herein.

The harness of the present application may be made by measuring out and cutting two 6′ lengths of tubular nylon. Two 5¼″ lengths of 3″ course weave, belt-like material may also be measured and cut. Each of the belt like fabrics may then be folded into a cylinder and sew along cut ends. Each of the cylinders may be folded in half and sewn again to create a figure-8 like sleeve. Velcro stays may then be sewn on one end of each of the two figure-8 sleeves. The first end of the nylon strap may then me threaded through one side of the figure-8 sleeve, which is opposite the side with the Velcro, and then through the adjoining side of the figure-8 sleeve. The strap may be pulled through the sleeves until the desired size of loop is achieved, and sew at e.g., about the 32″ mark, of the strap 4 to produce the about 16″ loop 10. The steps are repeated for the other strap and plastic male/female (cinching) snap buckle is attached to each free end of the strap.

When properly rigged, the harness provides an ergonomically pleasing, stable child/parent parade seat, which creates a common field of vision and an intimate mouth/ear relationship. These elements conspire over time to allow relaxed, focused excursions into the world. The proximity of the mouth of the child to the ear of the adult allows enhanced understanding of even the pre-verbal child's attempts at speech. The experience of an identical field of vision is perhaps unique in the lifespan of the child/parent relationship.

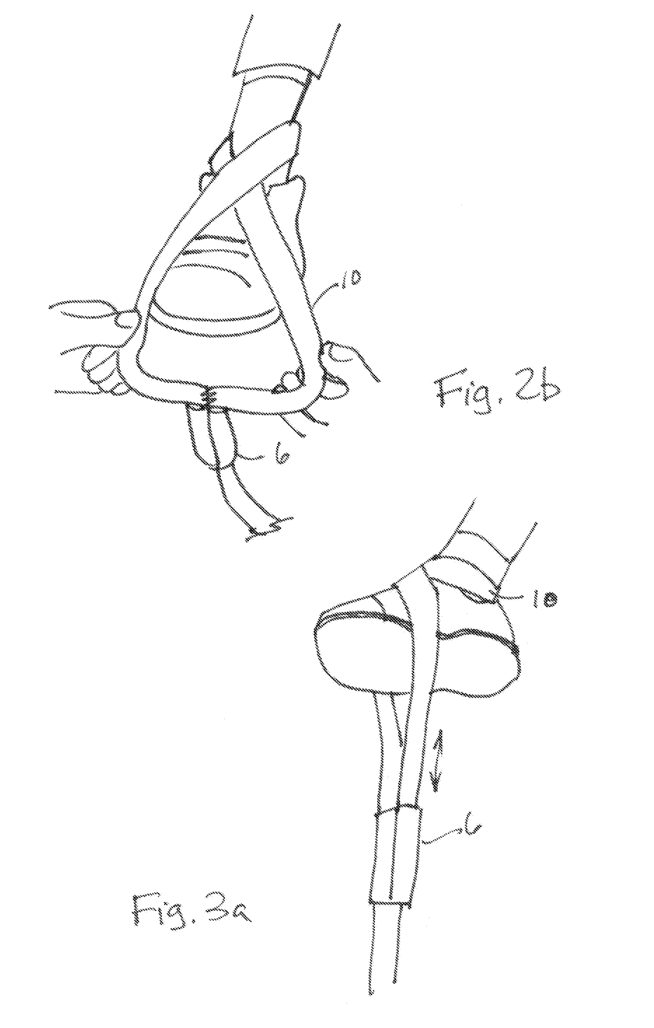

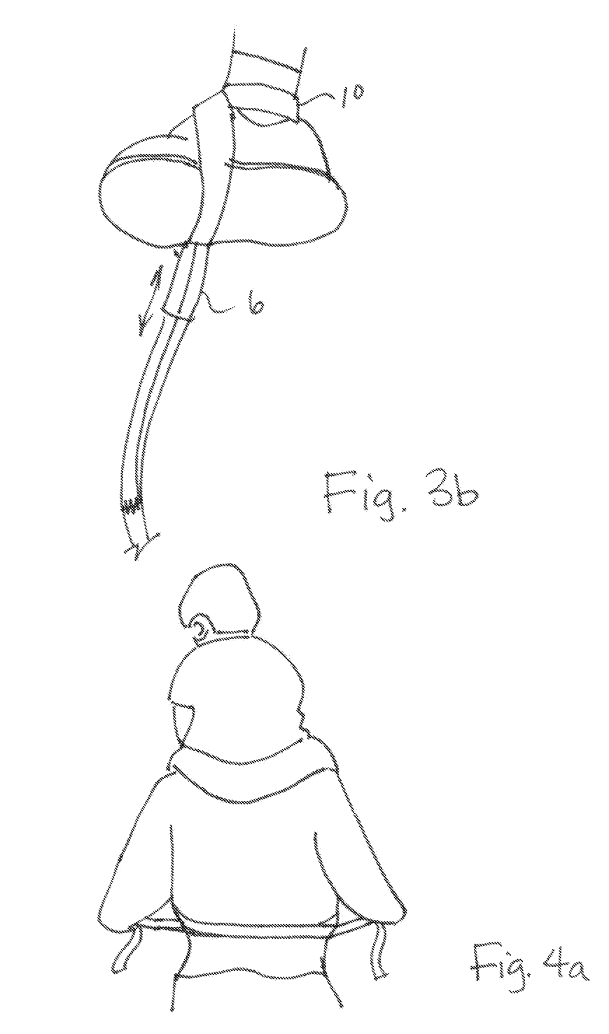

The procedure for attaching the harness to the child begins by securing each of the loops 10 of the straps 4 to the child's feet while the child is seated. This is accomplished by placing the child's ankle into the loop 10 as shown in FIG. 2a, followed by crossing the loop 10 over the top of the child's foot as shown in FIG. 2b. The remaining portion of the loop 10 is brought below the child's foot as shown in FIG. 3a. The loop 10 is then cinched closed by moving the tubular member 6 toward the child's foot or generally toward the first end, as shown in FIGS. 3b-3b.

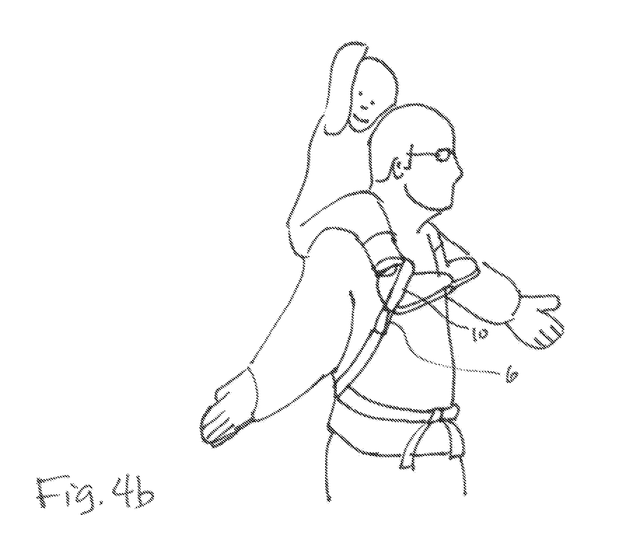

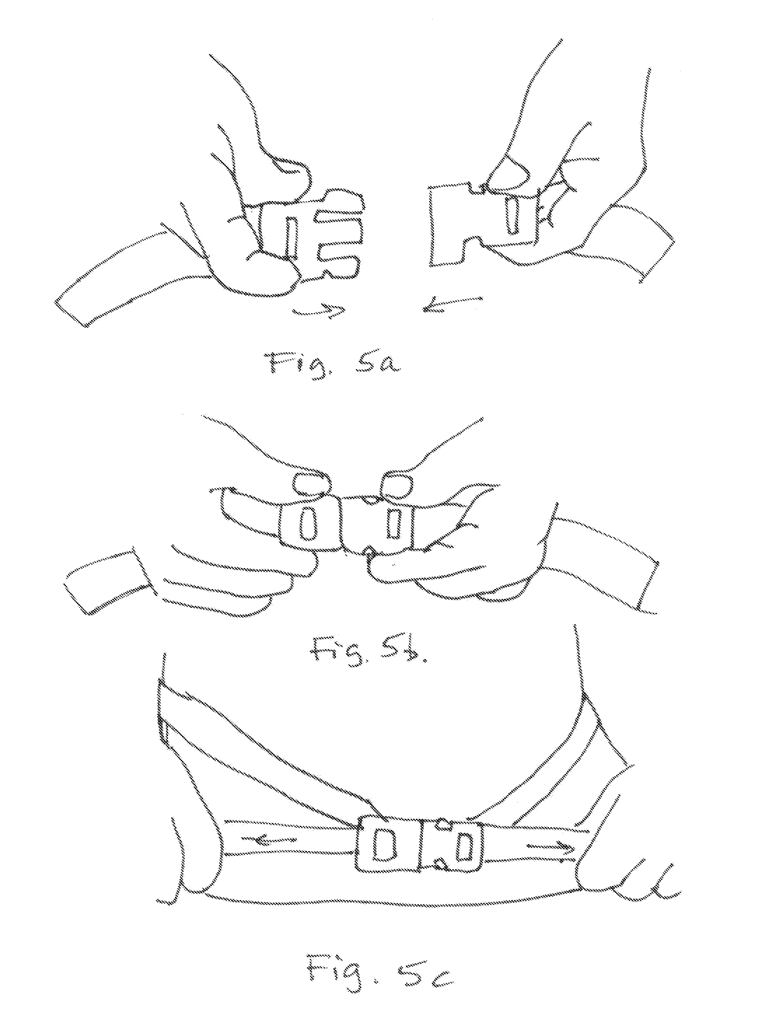

Once the straps 4 are secured to the child's feet, the child may then be allowed to climb up and straddle the neck of the adult. While seated, the loose ends of the strap 4 may be wrapped around the lower back of the adult and then buckled to each other at the front of the adult, as shown in FIGS. 4a-4b. Once buckled, the straps 4 are cinched so that the child's feet are held securely against the adult's chest, as shown in FIGS. 5a-5c.

Either strap also operates quite admirably as a walking lead. Simply loop the loop around the wrist of the child, cinch the loop tightly, and then rotate the loop so that the tubular member falls into the palm of the child's hand thereby allowing the child to grip the woven tubular member. This provides a 5′ lead for when the adult tires of the parade carry. It also allows the child 5′ of freedom and the adult 5′ of security.

While the foregoing invention has been described in some detail for purposes of clarity and understanding, it will be appreciated by one skilled in the art, from a reading of the disclosure that various changes in form and detail can be made without departing from the true scope of the invention.

What is claimed is:

1. A harness for securing a child in a parade carry position, the harness comprising:
a first strap having a first end and a second end opposite the first end, the first strap comprising a buckle at the second end; and
a second strap having a first end and a second end opposite the first end, the second strap comprising a buckle at the second end, wherein the buckle at the second end of the second strap is capable of being removably coupled to the buckle at the second end of the first strap, and wherein each of the first ends of the first and second strap include a cinchable loop.

2. The harness of claim 1, wherein at least one of the buckles at the second end of the first and second straps are cinchable.

3. The harness of claim 1, wherein the cinchable loop of at least one of the straps has a fixed length, and wherein the cinchable loop comprises a tubular member disposed over the fixed loop that is capable of sliding at least a portion of the length of the strap, the cinchable loop cinched by sliding the tubular member toward the first end of the strap and loosed by sliding the tubular member toward the second end of the strap.

4. The harness of claim 3, wherein the tubular member includes a plurality of tubular cavities extending lengthwise through the tubular member, and wherein the cinchable loop passes through both tubular cavities consecutively, the loop therewith forms a stop that prevents the tubular member from sliding off of the first end of the strap and sliding beyond the length of the loop toward the second end of the strap.

5. The harness of claim 4, wherein the tubular member has a figure-8 cross section.

6. The harness of claim 3, wherein the fixed length of the loop is from about 10″ to about 24″.

7. The harness of claim 3, wherein at least one of the straps has an overall length from about 4′ to about 6′.

8. The harness of claim 3, wherein the tubular member is made from a fabric material sewn into a tubular shape.

9. The harness of claim 3, wherein the tubular member comprises a sliding stop that prevents the tubular member from opening when in a cinched position.

10. A method for securing a child in a parade carry position, the method comprising:
securing to a child's foot a first strap having a first end and a second end opposite the first end, the first strap comprising a buckle at the second end;
securing to a child's other foot a second strap having a first end and a second end opposite the first end, the second strap comprising a buckle at the second end, wherein the buckle at the second end of the second strap is capable of being removably coupled to the buckle at the second end of the first strap, and wherein each of the first ends of the first and second strap include a cinchable loop to which the child's feet are secured;
locating the child on an adult's shoulders;
wrapping the second end of each of the first and the second straps around the adult's back; and
buckling the second ends of the straps to each other at the front of the adult.

11. The method of claim 10, wherein at least one of the buckles at the second end of the first and second straps are cinchable, the method comprising cinching the straps at the cinchable second end.

12. The method of claim 10, wherein the cinchable loop of at least one of the straps has a fixed length, and wherein the cinchable loop comprises a tubular member disposed over the fixed loop that is capable of sliding at least a portion of the length of the strap, the cinchable loop cinched by sliding the tubular member toward the first end of the strap and loosed by sliding the tubular member toward the second end of the strap, and wherein securing at least one of the child's fee comprises sliding the tubular member toward the first end of the strap.

13. The method of claim 12, wherein the tubular member includes a plurality of tubular cavities extending lengthwise through the tubular member, and wherein the cinchable loop passes through both tubular cavities consecutively, the loop therewith forms a stop that prevents the tubular member from sliding off of the first end of the strap and sliding beyond the length of the loop toward the second end of the strap.

14. The method of claim 13, wherein the tubular member has a figure-8 cross section.

15. The method of claim 12, wherein the fixed length of the loop is from about 10″ to about 24″.

16. The method of claim 12, wherein at least one of the straps has an overall length from about 4′ to about 6′.

17. The method of claim 12, wherein the tubular member is made from a fabric material sewn into a tubular shape.

18. The method of claim 12, wherein the tubular member comprises a sliding stop that prevents the tubular member from opening when in a cinched position.
